(19) United States
(12) Patent Application Publication
(10) Pub. No.: US 2017/0191758 A1
(43) Pub. Date: Jul. 6, 2017

(54) POWDER SINTERING DEVICE

(71) Applicants: JIANGSU HUADONG INSTITUTE OF LI-ION BATTERY CO., LTD., Suzhou (JP); TSINGUA UNIVERSITY, Beijing (CN)

(72) Inventors: Xiang-Ming He, Beijing (CN); Jian-Jun Li, Beijing (CN); Jian-Li Zhang, Beijing (CN); Li Wang, Beijing (CN); Jing Luo, Beijing (CN); Yu-Ming Shang, Beijing (CN); Cheng-Hao Xu, Beijing (CN); Jian Gao, Beijing (CN)

(73) Assignees: JIANGSU HUADONG INSTITUTE OF LI-ION BATTERY CO., LTD., Suzhou (CN); TSINGUA UNIVERSITY, Beijing (CN)

(21) Appl. No.: 15/466,028

(22) Filed: Mar. 22, 2017

Related U.S. Application Data
(63) Continuation of application No. PCT/CN2014/091944, filed on Nov. 21, 2014.

(30) Foreign Application Priority Data
Sep. 26, 2014 (CN) 201410500535.5

(51) Int. Cl. F27B 5/04; H01M 4/58; H01M 4/131; F23J 15/02; H01M 4/04; F27D 7/06; F27B 5/06; H01M 4/485; H01M 4/136

(52) U.S. Cl. CPC F27B 5/04; H01M 4/485; H01M 4/5825; H01M 4/131; H01M 4/136; H01M 4/0471; F27D 7/06; F27B 5/06; F23J 15/022; F27B 2005/161

(57) ABSTRACT

A powder sintering device is disclosed. The powder sintering device includes a furnace body, a first heating device, and a vibration device. The furnace body includes a bottom wall and a side wall cooperatively defining a reaction chamber. The first heating device is located outside the furnace body, and configured to heat the furnace body. The vibration device is located outside the furnace body, and configured to vibrate the furnace body.

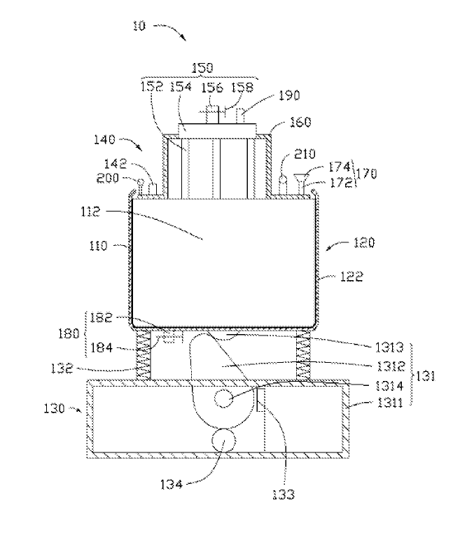

### CROSS-REFERENCE TO RELATED APPLICATIONS

This application claims all benefits accruing under 35 U.S.C. §119 from China Patent Application No. 201410500535.5, filed on Sep. 26, 2014 in the State Intellectual Property Office of China, the content of which is hereby incorporated by reference. This application is a continuation under 35 U.S.C. §120 of international patent application PCT/CN2014/091944 filed on Nov. 21, 2014, the content of which is also hereby incorporated by reference.

### FIELD

The present disclosure relates to powder sintering devices and, particularly, to a powder sintering device for dynamic sintering with aid of vibration.

### BACKGROUND

Energy efficiency is important in the development of human society, science and technology. A lithium-ion battery is widely used in notebook computer, mobile phone, camera, and other consumer electronic product, as a primary and a green secondary battery with a high energy density. Cathode active material and anode active material are important components of the lithium-ion battery. A common method to prepare the cathode active material and the anode active material of the lithium-ion battery is powder sintering.

A conventional powder sintering device commonly adopts a static sintering process to prepare the cathode active material and the anode active material of the lithium-ion battery. Because powder is stacked in the static sintering process, the sintering temperature difference inside the stacked powder and outside of the stacked powder can be significant. In addition, the raw powder may not be evenly mixed. Thus, in a static sintering process, powder sintering may be non-uniform, a part of the stacked powder may not be fully sintered, and the product yield of the powder sintering is relatively low.

### BRIEF DESCRIPTION OF THE DRAWINGS

Implementations are described by way of example only with reference to the attached FIGURE.

The FIGURE is a cross-sectional view of one embodiment of a powder sintering device.

### DETAILED DESCRIPTION

It will be appreciated that for simplicity and clarity of illustration, where appropriate, reference numerals have been repeated to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Referring to the FIGURE, one embodiment of a powder sintering device 10 is disclosed. The powder sintering device 10 includes a furnace body 110, a first heating device 120, a vibration device 130, a gas introducing device 140, an exhaust device 150, a second heating device 160, a feed device 170, and a discharge device 180.

The furnace body 110 includes a bottom wall and a side wall extending from an edge of the bottom wall. The bottom wall and the sidewall cooperatively define a reaction chamber 112 with a closed structure. A structure of the furnace body 110 is not limited. For example, the furnace body 110 can be a hollow cylinder shaped structure or a hollow prism shaped structure according to actual needs. The hollow prism shaped structure can be a hollow quadrangular prism, a hollow pentagonal prism, or a hollow hexagonal prism.

A material of the furnace body 110 can be selected from heat resistance materials. A surface coating layer can be coated on an inner wall of the furnace body 110 to prevent powder from adhering to the inner wall of the furnace body 110 during sintering. The surface coating layer can be a ceramic-based coating, a graphite-based coating, a polytetrafluoroethylene coating, or other high temperature resistant coatings. The surface coating layer can prevent the introduction of metallic impurities such as iron and can make the production process cleaner.

The first heating device 120 can include a heating element 122 and a thermocouple (not shown). The heating element 122 is located outside the furnace body 110 for heating the furnace body 110. The first heating device 120 can heat the furnace body 110 to raise the temperature in the reaction chamber 112 to a range from about 100° C. to about 1300° C. In one embodiment, the heating element 122 of the first heating device 120 is a resistance wire wound around an outer surface of the furnace body 110. The thermocouple can be located inside or outside the reaction chamber 112 for detecting the temperature in the reaction chamber 112. It is to be understood that the first heating device 120 can be disposed at one side of the outer surface of the furnace body 110.

In one embodiment, the first heating device 120 can further include a thermal insulating layer (not shown) applied on an outer surface of the first heating element 122 and a protecting layer (not shown) applied over the thermal insulating layer. Alternatively, the thermal layer can be applied over the protecting layer. The thermal insulating layer and the protecting layer can also be coated layer by layer on an outer surface of the heating element 122. The thermal insulating layer and the protecting layer may also be applied on any part or component of the powder sintering device 10 such as the furnace body 110.

The vibration device 130 can be located outside the furnace body 110 to vibrate the furnace body 110. A collision probability and the contact area between powder particles in the reaction chamber 112 are increased during the sintering process with increased or added vibration of the furnace body 110, so that the powder is uniformly mixed. In one embodiment, the vibration device 130 is located under the furnace body 110 to vibrate the furnace body 110 in one or more directions. The furnace body 110 can be vibrated in any direction, such as a vertical up and down motion against the force of gravity, side to side motion, or random motion in various directions. In one embodiment, the vibration device 130 contacts the bottom wall of the furnace body 110 for vibrating the furnace body 110 vertically in a direction against gravity.

The vibration device 130 can include a driving machine (not shown), a cam mechanism 131, at least one elastic element 132, a brake element 133, and a bearing wheel 134. The driving machine can be a motor or other driving element. In one embodiment, the driving machine is a motor.

The cam mechanism 131 includes a fixed rack 1311, a main shaft 1314, a cam 1312, and a protruding block 1313. The fixed rack 1311 can be a hollow rectangular shaped structure with an opening at an upper part of the fixed rack 1311. The main shaft 1314 can be a cylindrical shaft. The cam 1312 can be a disc-shaped cam. The driving machine, the main shaft 1314, and the bearing wheel 134 can be located inside the fixed rack 1311. The main shaft 1314 can be connected to the driving machine via a universal joint (not shown) or other device or assembly which allows the main shaft to rotate and move in one or more directions. The cam 1312 can be arranged on the main shaft 1314, and can be rotated together with the main shaft 1314 to perform a rotational movement around a central axis or axis of rotation of the main shaft 1314. The bearing wheel 134 can be rotatable about a bearing wheel axis fixed between the cam 1312 and a bottom of the fixed rack 1311. The bearing wheel 134 can be in continuous contact with the cam 1312 while the cam 1312 is rotating. The cam 1312 can have different radii around the perimeter of the cam 1312 to form an eccentric shaped cam so that rotation of the cam 1312 will result in a specific rocking or reciprocating linear motion of the cam follower in contact with the cam 1312. Because the bearing wheel 1314 is fixed inside the fixed rack 1311 and limited to only rotational movement and maybe some movement along the bearing wheel axis, as the cam 1312 rotates, the main shaft 1314 must move in a direction between the fixed rack 1311 and the furnace body 110, shown as an up-and-down movement towards and away from the bottom of the fixed rack 1311 in the FIGURE. In one embodiment, the main shaft 1314 can not only rotate by operation of the driving machine, but can move up and down between the furnace body 110 and the fixed rack 1311. Accordingly, the cam 1312, which is fixed to the main shaft 1314, must also move along with the main shaft 1314.

The protruding block 1313 can be disposed outside the furnace body 110, and contact the cam 1312. The protruding block 1313 can serve as a cam follower of the cam 1312 and be in continuous contact with the cam 1312 while the cam 1312 is rotating. In one embodiment, the protruding block 1313 is located on the first heating device 120 at the bottom of the furnace body 110. It is to be understood that if the protruding block 1313 can be directly arranged on an outer bottom surface of the furnace body 110, the first heating device 120 is located so as to not cause interference with the other components including the cam 1312. Shapes of the fixed frame 1311 and the main shaft 1314, and the connecting manner between the main shaft 1314, the driving machine, and the cam 1312, are not limited to the description of present embodiment, and can be designed according to actual needs.

The cam 1312 can continuously rotate by operation of the driving machine to drive the furnace body 110 to oscillate back and forth along one or more directions, such as a vertical direction, thereby forming a vibration. The main shaft 1314 is connected to the driving machine. The driving machine can drive the main shaft 1314 rotating at a constant speed, and allow the main shaft 1314 to move in one or more directions while the main shaft 1314 is rotating. In some embodiments, the driving machine can move with the main shaft 1314 so that a universal joint may not be needed. Because the cam 1312 is fixed on the main shaft 1314, the driving machine can drive the cam 1312 to rotate via the main shaft 1314 around the central axis of the main shaft 1314. When the cam 1312 is continuously rotated, because the protruding block 1313 is contacting the cam 1312, the protruding block 1313 can move rapidly back and forth along one or more directions to form a vibration along the one or more directions as the cam 1312 rotates. Thus, the rotation of the cam 1312 causes the furnace body 110 to oscillate or vibrate in one or more directions, such as the vertical direction or direction of gravity. The weight of the furnace body 110 can ensure continuous contact between the protruding block 1313 or the bearing wheel 134 and the cam 1312. In one embodiment, the furnace body 110 is at a lowest position when the surface of the cam 1312 contacting the protruding block 1313 is located closest to the axis of rotation of the cam 1312, and the furnace body 110 is elevated to a highest position when the surface of the cam 1312 contacting the protruding block 1313 is located farthest to the axis of rotation of the cam 1312. In one embodiment, a vibration or oscillation amplitude of the furnace body 110 is smaller than one tenth of the height of the furnace body 110, and a vibration or oscillation frequency of the furnace body 110 is in a range from equal to or greater than 1/12 Hz to equal to or less than ⅓ Hz. The vibration or oscillation frequency can be in a periodic pattern or irregular pattern. The described vibration or oscillation amplitude and frequency can facilitate the stability of the powder sintering device 10 and uniformly mix the powder. In one embodiment, a rotational speed of the cam 1312 can be in a range equal to or greater than 5 revolutions per minutes (rev/min) and less than or equal to 20 rev/min. The described rotational speed of the cam 1312 is not only for uniformly mixing the powder, but also to facilitate stability of the powder sintering device 10 and reduction in energy consumption. It is to be understood that the cam 1312 can be a moving cam, a cylindrical cam or other type and shape of cam as long as the vibration of the furnace body 110 can be achieved. In one embodiment, the cam 1312 is a plate cam or radial cam.

The protruding block 1313 can have a curved surface. The use of the protruding block 1313 avoids friction between the cam 1312 and the first heating system 120 or the furnace body 110 when the cam 1312 and the protruding block 1313 are directly in contact with each other. Therefore, the protruding block 1313 is conducive to reduce the energy consumption during the induced vibration of the furnace body 110. It is to be understood that the protruding block 1313 is optional, and the cam 1312 can directly contact a surface of the first heating system 120 or the furnace body 110. In one embodiment, the protruding block 1313 can directly contact the outer bottom surface of the furnace body 110 when the first heating device 120 is disposed only at a side of the furnace body 110.

The elastic element 132 can be located between the furnace body 110 and the fixed rack 1311. The fixed rack 1311 can be connected to the furnace body 110 via the elastic element 1311. One end of the elastic element 132 can be connected to the first heating device 120 at the bottom of the furnace body 110, and another end of the elastic element 132 can be connected to the fixed rack 1311. The elastic element 132 is configured to provide an elastic connection between the fixed rack 1311 and the furnace body 110. The vibration or oscillation amplitude and location of the furnace body 110 is adjustable when the elastic element 132 compresses, deflects, or extends with the vibration or oscillation of the furnace body 110. It is to be understood that the elastic element 132 can directly connect to the bottom of furnace body 110 when the first heating device 120 is provided only at the side of the furnace body 110. The location of the elastic element 132 is not limited and can be adjusted according to actual needs as long as the vibration or oscillation amplitude and location of the furnace body 110 are adjustable. The elastic element 132 can be disposed on a top or side of the furnace body 110. An amount of the elastic element 132 is not limited and can be selected according to actual needs. In one embodiment, two elastic elements 132 are provided in the powder sintering device 10.

The brake element 133 can be disposed near the cam 1312 and configured to stop rotation of the cam 1312. The brake element 133 does not contact the cam 1312 when the cam 1312 does not need to stop or slow down during rotating. The brake element 133 is contacted with the cam 1312 when the cam 1312 needs to stop or slow down during rotating.

The bearing wheel 134 can be located between the cam 1312 and the bottom of the fixed rack 1311. Because the main shaft 1314 is rotated together with the cam 1312 around the central axis of the main shaft 1314, the main shaft 1314 has an up-and-down movement relative to the fixed rack 1311 when the cam 1312 is continuously rotated. The bearing wheel 134 is always contacted with the cam 1312 during the continuously rotating of the cam 1312. The bearing wheel 134 can be rotated along a direction contrary to the rotation direction of the cam 1312. A rotation axis of the bearing wheel 134 is parallel to the central axis which the cam 1312 rotates around. The bearing wheel 134 can decrease the friction between the cam 1312 and fixed rack 1311.

It is can be understood that the elastic element 132, the brake element 133, and the bearing wheel 134 are optional.

The gas introducing device 140 can be configured to input a protecting gas into the reaction chamber 112. The protecting gas can be an oxidizing gas, a reducing gas, or an inert gas. The protecting gas can prevent the powder in the reaction chamber 112 from oxidation or reduction, and adjust moving trajectory of the powder in the reaction chamber 112. Therefore, the powder in the reaction chamber 112 can be uniformly mixed and well sintered. The gas introducing device 140 can include an intake pipe 142 and a gas supply device (not shown) connected to the intake pipe 142. A location and arrangement of the intake pipe 142 is not limited and can be selected according to actual needs. In one embodiment, the intake pipe 142 can be located on the top of the furnace body 110. In order to prevent the intake pipe 142 from being damaged at a high temperature, a high temperature resistant filter can be located at an outlet of the intake pipe 142. It is can be understood that the gas introducing device 140 is optional and can be arranged according to actual needs. In one embodiment, the gas introducing device 140 can include one intake pipe 142.

The exhaust device 150 is configured to promptly discharge sintered products such as hot smoke and gas in the sintering process. The exhaust device 150 can include a gas-solid separating unit 152, a gas buffer unit 154, an exhaust pipe 156, and an automatic control valve 158. The gas-solid separating unit 152 is located on the top of the furnace body 110 to prevent the exhaust pipe 156 from clogging. The gas-solid separating unit 152 can include heat resistance elements such as a gas-solid separator, a filter screen, and a pulsed reverse-inflating element. The gas buffer unit 154 is located on one end of the gas-solid separating unit 152, and the end is away from the furnace body 110. The exhaust pipe 156 is located on one end of the gas-solid separating unit 152, and the end is away from the furnace body 110. The automatic control valve 158 is disposed on the exhaust pipe 154. The automatic control valve 158 can automatically open the exhaust pipe 156 when the pressure inside the reaction chamber 112 exceeds a set value.

The second heating device 160 is configured to heat the exhaust device 150, so as to prevent sublimate material generated in the reaction chamber 112 during sintering process from condensing in the exhaust device 150, and not being discharged from the exhaust device 150. The second heating device 160 can be disposed outside of the exhaust device 150. The second heating device 160 can have a same vibration or oscillation frequency as the vibration or oscillation frequency of the vibration device 130, so as to uniformly heat the exhaust device 150. In one embodiment, the second heating device 160 is a low-temperature heating system having a heating temperature in a range from about 0° C. to about 500° C., and can be a water bath or an oil bath.

The feed device 170 can be located on the top of the furnace body 110, and capable of feeding powder into the reaction chamber 112 of the furnace body 110. In one embodiment, the feed device 170 is positioned on the top of the furnace body 110 so that the powder can drop to the bottom of the furnace body 110 by its own weight. The feed device 170 can include a feed pipe 172, a tapered container 174, and a butterfly valve (not shown). The butterfly valve is located between the feed pipe 172 and the tapered container 174. The tapered container 174 is connected to the reaction chamber 112 through the feed pipe 172. The powder can be temporarily stored in the tapered container 174. During the feeding, the powder is transferred from the tapered container 174 into the feed pipe 172 through the butterfly valve, and fed gradually into the reaction chamber 112 through the feed pipe 172.

The discharge device 180 is located on a lower portion of the side wall of the furnace body 110 for discharging the sintered powder from the reaction chamber 112. The discharge device 180 can include a discharge pipe 182 and a control valve 184. The control valve 184 is located on the discharge pipe 182. When the powder is to be discharged after the sintering of the powder is completed, the control valve 184 is opened to discharge the sintered powder out the reaction chamber 112. It is to be understood that the amount of the feed devices 170 and the discharge devices 180 each can be two or more.

The powder sintering device 10 can further include a vacuuming device 190 for drawing out the air in the reaction chamber 112, and keeping the reaction chamber 112 in vacuum. In one embodiment, the vacuuming device 190 is located at one end of a gas-solid separating unit 152, and the end is away from the furnace body 110. It is to be understood that when the reaction chamber 112 is in a vacuum state, the vibration device 130 can be disposed at any position outside the furnace body 110 just as long as the furnace body 110 can be mechanically vibrated.

The powder sintering device 10 can further include a pressure sensing device 200. The pressure sensing device 200 is used for detecting the gas pressure in the reaction chamber 112. The pressure sensing device 200 can be located on the top of the furnace body 110. The powder sintering system 10 can further include a gas testing device (not shown). The gas testing device is used for detecting the gas components in the reaction chamber 112.

The powder sintering device 10 can further include a viewing window 210 to facilitate viewing of the state of the powder in the reaction chamber 112 during the sintering process. The viewing window can be located on the sidewall or the top of the furnace body 110.

The powder sintering device 10 can be used for preparing a cathode active material or an anode active material of a lithium ion battery, which are mainly lithium transition metal composite oxides, such as lithium iron phosphate, lithium cobalt oxide, lithium manganese oxide, lithium nickel oxide, and lithium titanate.

A working principle of the powder sintering device 10 is explained as follows. Powder is temporarily stored in the tapered container 172. When feeding of the powder is needed, the powder is transferred into the feed pipe 172 and is gradually fed into the reaction chamber 112 via the feed pipe 172. When the powder reaches the bottom of the furnace body 110, the powder is continuously tossed in the reaction chamber 112 during the variation of the furnace body 110. The powder particles are collided and diffusely mixed when the powder is tossed up and down during the variation of the furnace body 110. The temperature of the reaction chamber 112 is in a range from about 100° C. to about 1000° C., the powder is sintered during the mixing. Since the powder particles collide with each other and exhibit a suspension state, the powder can be uniformly heated and mixed in the powder sintering device 10 to complete the sintering of the powder.

The powder sintering device provided in the present disclosure has the following characteristics. First, the dynamic sintering of the powder inside the furnace body can be realized by rationally arranging the vibration device so that the powder can be uniformly dispersed in the sintering process. The collision probability and contact area between the powder particles is increased so as to achieve efficient powder sintering. Second, in the powder sintering process, only the intake pipe and the feed pipe communicate with the outside environment, which makes the powder sintering device sealed well. Third, due to the installation of the gas introducing device and the exhaust device, the sintering process under a certain protective atmosphere can be achieved. In addition, the powder sintering device also has advantages of a small occupying space, high sintering efficiency, and clean production.

Other embodiments of the disclosure will be apparent to those skilled in the art from consideration of the specification and practice of the embodiments disclosed herein. It is intended that the specification and examples be considered as exemplary only, with the true scope and spirit of the embodiments being indicated by the following claims.

What is claimed is:

1. A powder sintering device, comprising:
a furnace body comprising a bottom wall and a side wall extending from the bottom wall, the bottom wall and the sidewall cooperatively defining a reaction chamber;
a first heating device located outside the furnace body, and configured to heat the furnace body; and
a vibration device located outside the furnace body, the vibration device being configured to vibrate the furnace body in at least one vibration direction.

2. The powder sintering device of claim 1, wherein the vibration device contacts the bottom wall of the furnace body for vibrating the furnace body, and the at least one vibration direction comprises a direction of gravity.

3. The powder sintering device of claim 2, wherein the first heating device is located on an outer surface of the furnace body, and the vibration device is attached to the first heating device.

4. The powder sintering device of claim 2, wherein the vibration device comprises a cam mechanism driven by a driving machine, the cam mechanism comprising:
a fixed rack;
a main shaft located inside the fixed rack, the main shaft being driven to rotate by the driving machine; and
a cam arranged on the main shaft, the cam being configured to rotate together with the main shaft to contact the bottom wall of the furnace body to move the furnace body in the at least one vibration direction.

5. The powder sintering device of claim 4, wherein the cam mechanism further comprises a protruding block connected to the bottom of the furnace body, and the protruding block continuously contacts the cam.

6. The powder sintering device of claim 4, wherein the furnace body is at a lowest position when the surface of the cam contacting the protruding block is located closest to the axis of rotation of the cam, the furnace body is elevated to a highest position when the surface of the cam contacting the protruding block is located farthest to the axis of rotation of the cam.

7. The powder sintering device of claim 4, further comprising at least one elastic element connected between the furnace body and the fixed rack.

8. The powder sintering device of claim 6, wherein one end of the at least one elastic element is connected to the bottom of the furnace body, and another end of the at least one elastic element is connected to the fixed rack.

9. The powder sintering device of claim 4, wherein the vibration device further comprises a bearing wheel located between the cam and a bottom of the fixed rack, the bearing wheel contacting the cam.

10. The powder sintering device of claim 4, wherein a rotational speed of the cam is in a range equal to or greater than 5 revolutions per minutes (rev/min) and less than or equal to 20 r/min.

11. The powder sintering device of claim 1, wherein a vibration or oscillation amplitude of the furnace body is less than one tenth of a height of the furnace body.

12. The powder sintering device of claim 1, wherein a vibration or oscillation frequency of the furnace body is greater than or equal to 1/12 Hz and less than or equal to ⅓ Hz.

13. The powder sintering device of claim 1, further comprising an exhaust device configured to exhaust gas produced in the reaction chamber in a sintering process, the exhaust device comprising a gas-solid separating unit, an automatic control valve, a gas buffer unit, and an exhaust pipe, wherein the gas-solid separating unit is located on a top of the furnace body, the gas buffer unit is located on an end of the gas-solid separating unit away from the furnace body, the exhaust pipe extending from an end of the gas buffer unit, and the automatic control valve is located on the exhaust pipe.

14. The powder sintering device of claim 13, further comprising a second heating device located outside the exhaust device for heating the exhaust device.

15. The powder sintering device of claim 13, further comprising a gas introducing device located on the top of the furnace body for inputting a protecting gas into the reaction chamber.

16. The powder sintering device of claim 1, further comprising a feed device located on a top of the furnace body.
